(19) United States
(12) Patent Application Publication
(10) Pub. No.: US 2009/0169108 A1
(43) Pub. Date: Jul. 2, 2009

(54) SYSTEM AND METHOD FOR RECOGNIZING SMILING FACES CAPTURED BY A MOBILE ELECTRONIC DEVICE

(75) Inventor: MENG-CHIEH CHOU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: Chi Mei Communication Systems, Inc., Tu-Cheng City (TW)

(21) Appl. No.: 12/336,461

(22) Filed: Dec. 16, 2008

(30) Foreign Application Priority Data
Dec. 27, 2007 (CN) 200710203477.X

(51) Int. Cl. G06K 9/46; H04N 5/76

(52) U.S. Cl. 382/190; 348/231.99

(57) ABSTRACT

A method for recognizing smiling faces captured by a camera of a mobile electronic device is provided. The method includes capturing an actual facial image of a user using the camera, and storing the actual facial image into a memory system of the mobile electronic device. The method further includes extracting facial features of the intensity image according to a luminance of each pixel of the intensity image. Furthermore, the method includes deleting the actual facial image from the memory system in response to the determination that the intensity image does not satisfy the predetermined smiling face identifying standard.

### BACKGROUND

1. Field of the Invention

Embodiments of the present disclosure are related to face recognition systems and methods, and particularly to a system and method for recognizing smiling faces captured by a mobile electronic device.

2. Description of Related Art

A mobile electronic device is a pocket-sized computing device, which includes a small visual display for output and a miniature keyboard or touch screen for input. Currently, mobile electronic devices have many auxiliary functions, such as a function for capturing images. Usually, when people take photos of a person using a mobile electronic device, they would like to capture images at the moment the person smiles brilliantly, and store these images with other people who are smiling. However, capturing these moments is often difficult to do because a person is often blinking, looking away, or not smiling at the proper moment.

What is needed, therefore, is a system and method for automatically overcoming the aforementioned problem.

### BRIEF DESCRIPTION OF THE DRAWINGS

FIG. 1 is a block diagram of one embodiment of a system for recognizing smiling faces captured by a mobile electronic device.

FIG. 2 is a flowchart of one embodiment of a method for recognizing smiling faces captured by a mobile electronic device.

FIG. 3 illustrates one embodiment of facial features of a smiling face.

### DETAILED DESCRIPTION OF CERTAIN INVENTIVE EMBODIMENTS

All of the processes described below may be embodied in, and fully automated via, function modules executed by one or more general purpose processors of a mobile electronic device. Some or all of the methods may alternatively be embodied in specialized hardware. The function modules may be stored in any type of computer-readable medium or other computer storage device.

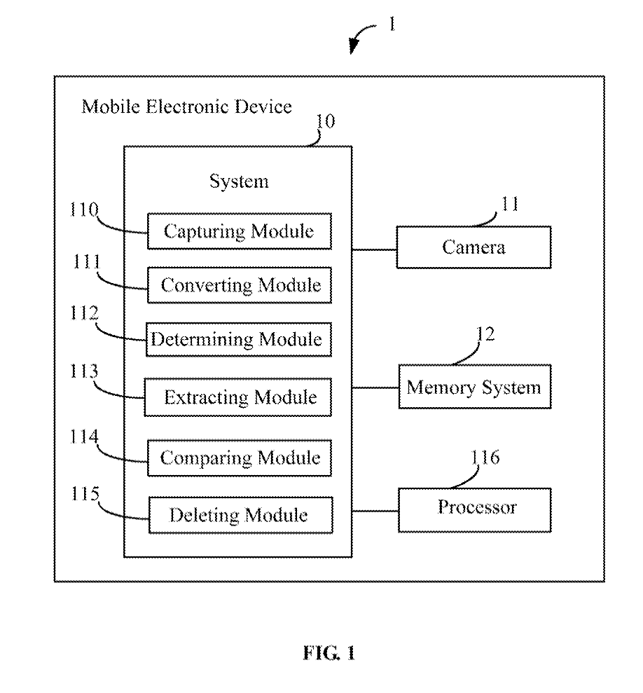

FIG. 1 is a block diagram of one embodiment of a system 10 for recognizing smiling faces captured by a mobile electronic device 1. In one embodiment, the mobile electronic device 1 may include a camera 11 and a memory system 12. The camera 11 captures images of objects, such as a person. The camera 11 captures a facial image of the person. The facial image of the person may show the person smiling, frowning, feeling content, for example.

The system 10 determines whether a person is smiling based on facial characteristics of a person's facial image captured by the camera 11, a smiling image model and a smiling face identifying standard. For example, if a person is smiling, the person's mouth is open and the person's eyes are smaller than usual when the user does not smile. The smiling face identifying standard defines a similarity degree between the facial features of an intensity image and the facial features of the smiling image model. For example, the similarity degree may be set at 60%.

The memory system 12 pre-stores the smiling image model and the smiling face identifying standard. In one embodiment, the smiling image model comprises facial features of a person, such as the person's hair, eyes, and nose when the person is smiling. The memory system 12 may be an internal memory system card or an external memory system card. The external memory system card may include a smart media card (SMC), a secure digital card (SDC), a compact flash card (CFC), a multi media card (MMC), a memory system stick (MS), an extreme digital card (XDC), and a trans flash card (TFC). Depending on the embodiment, the mobile electronic device 1 may be a mobile phone, a personal digital assistant (PDA), a handheld game player, a digital camera, among other portable electronic devices with an image capturing function.

The system 10 comprises a plurality of functional modules for determining if an image captured by the camera 11 satisfies the smiling face identifying standard, and deleting the image from the memory system 12 if the image does not satisfy the smiling face identifying standard. In one embodiment, the system 10 includes a capturing module 110, a converting module 111, a determining module 112, an extracting module 113, a comparing module 114, and a deleting module 115. The modules 110, 111, 112, 113, 114, 115 may be used to execute one or more operations for the mobile electronic device 1. Additionally, the mobile electronic device 1 may comprise one or more specialized or general purpose processors, such as a processor 116, for executing the modules 110, 111, 112, 113, 114, 115.

The capturing module 110 is configured for capturing an actual facial image of a user using the camera 11 of the mobile electronic device 1, and storing the actual facial image into the memory system 12. In one embodiment, the actual facial image may be a digital image.

The converting module 111 is configured for converting the actual facial image into an intensity image. The intensity image, in one embodiment, is a black and white image having a plurality of pixels.

The determining module 112 is configured for determining a luminance of each pixel of the intensity image. It may be understood that the luminance of each pixel may be determined by an amount of reflection of each pixel in the intensity image in one embodiment.

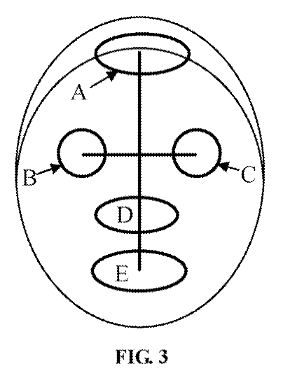

The extracting module 113 is configured for extracting facial features of the intensity image according to the luminance of each pixel of the intensity image. In one embodiment, the facial features comprise the relative sizes and relative locations of hair, eyes, nose, and mouth of the user. As shown in FIG. 3, illustrating one embodiment of facial features denoted as circles A, B, C, D and E. In FIG. 3, the circles A, B, C, D and E respectively denote the hair, the eyes, the nose, the mouth of the user.

The comparing module 114 is configured for comparing the facial features of the intensity image with the facial features of the smiling image model, so as to determine if the intensity image satisfies the predetermined smiling face identifying standard, such as the similarity degree of 60%. In one embodiment, if the similarity degree between each facial feature of the intensity image and each corresponding facial feature of the smiling image model is more than or equal to 60%, the intensity image is regarded as a smiling image.

The deleting module 116 is configured for deleting the actual facial image from the memory system 12 in response to the determination that the intensity image does not satisfy the predetermined smiling face identifying standard.

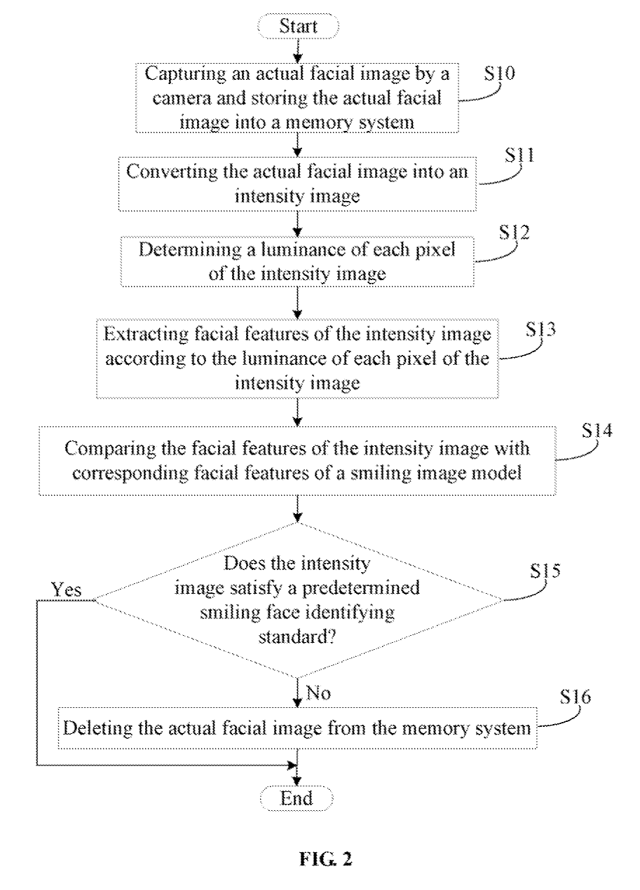

FIG. 2 is a flowchart of one embodiment of a method for recognizing smiling faces captured by a mobile electronic device 1. Depending on the embodiment, additional blocks may be added, while others deleted, and the blocks may also be executed in a different order than described.

In block S10, the capturing module 110 captures an actual facial image of a user using the camera 11 of the mobile electronic device 1, and stores the actual facial image into the memory system 12. As mentioned above, the actual facial image may be a digital image.

In block S11, the converting module 111 converts the actual facial image into an intensity image.

In block S12, the determining module 112 determines a luminance of each pixel of the intensity image.

In block S13, the extracting module 113 extracts facial features of the intensity image according to the luminance of each pixel of the intensity image. As mentioned above, the facial features comprise hair, eyes, nose, and mouth of the user. A detailed description is as follows (the following description uses just eyes for example). In one embodiment, as shown in FIG. 3, the circles B and C in the intensity image may be displayed as being darker than other circles A, D, E. The extracting module 113 extracts the circles B and C as eyes from the intensity image.

In block S14, the comparing module 114 compares the facial features of the intensity image with corresponding facial features of the smiling image model one by one. For example, the comparing module 114 compares the relative sizes and relative locations of the hair circle A, and the nose circle D in the intensity image with sizes and locations of a hair circle and a nose circle of the smiling image model respectively.

In block S15, the comparing module 114 determines if the intensity image satisfies the predetermined smiling face identifying standard according to the comparison result. In one embodiment, the comparing module 114 determines the intensity image satisfies the predetermined smiling face identifying standard, if similarity degree between each facial feature of the intensity image and a corresponding facial feature of the smiling image model is less than 60%, then the procedure goes to block S16. Otherwise, the procedure ends.

In block S16, the deleting module 116 deletes the actual facial image from the memory system 12 in response to the determination that the intensity image does not satisfy the predetermined smiling face identifying standard.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for recognizing smiling faces captured by a camera of a mobile electronic device, the system comprising:
a capturing module configured for capturing an actual facial image of a user using the camera, and storing the actual facial image into a memory system of the mobile electronic device;
a converting module configured for converting the actual facial image into an intensity image;
a determining module configured for determining a luminance of each pixel of the intensity image;
an extracting module configured for extracting facial features of the intensity image according to the luminance of each pixel of the intensity image;
a comparing module configured for comparing the facial features of the intensity image with corresponding facial features of a smiling image model that is pre-stored in the memory system, so as to determine if the intensity image satisfies a predetermined smiling face identifying standard; and
a deleting module configured for deleting the actual facial image from the memory system in response to the determination that the intensity image does not satisfy the predetermined smiling face identifying standard.

2. The system of claim 1, wherein the predetermined smiling face identifying standard defines a similarity degree between the facial features of the intensity image and the facial features of the smiling image model.

3. The system of claim 2, wherein the facial features comprise relative sizes and relative locations of hair, eyes, nose, and mouth of the user.

4. The system of claim 1, wherein the intensity image is a black and white image.

5. The system of claim 1, wherein the mobile electronic device is selected from the group consisting of a mobile phone, a personal digital assistant (PDA), a handheld game player, and a digital camera.

6. The system of claim 1, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

7. A computer-implemented method for recognizing smiling faces captured by a camera of a mobile electronic device, the method comprising:
capturing an actual facial image of a user using the camera, and storing the actual facial image into a memory system of the mobile electronic device;
converting the actual facial image into an intensity image;
determining a luminance of each pixel of the intensity image;
extracting facial features of the intensity image according to the luminance of each pixel of the intensity image;
comparing the facial features of the intensity image with corresponding facial features of a smiling image model that is pre-stored in the memory system, so as to determine if the intensity image satisfies a predetermined smiling face identifying standard; and
deleting the actual facial image from the memory system in response to the determination that the intensity image does not satisfy the predetermined smiling face identifying standard.

8. The method of claim 7, wherein the predetermined smiling face identifying standard defines a similarity degree between the facial features of the intensity image and the facial features of the smiling image model.

9. The method of claim 8, wherein the facial features comprise relative sizes and relative locations of hair, eyes, nose, and mouth of the user.

10. The method of claim 7, wherein the intensity image is a black and white image.

11. The method of claim 7, wherein the mobile electronic device is selected from the group consisting of a mobile phone, a personal digital assistant (PDA), a handheld game player, and a digital camera.

12. The method of claim 7, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

13. A storage medium having stored thereon instructions that, when executed by a mobile electronic device, causing the mobile electronic device to perform a method for recognizing smiling faces captured by a camera of a mobile electronic device, the method comprising:
capturing an actual facial image of a user using the camera, and storing the actual facial image into a memory system of the mobile electronic device;
converting the actual facial image into an intensity image;
determining a luminance of each pixel of the intensity image;
extracting facial features of the intensity image according to the luminance of each pixel of the intensity image;
comparing the facial features of the intensity image with corresponding facial features of a smiling image model that is pre-stored in the memory system, so as to determine if the intensity image satisfies a predetermined smiling face identifying standard; and
deleting the actual facial image from the memory system in response to the determination that the intensity image does not satisfy the predetermined smiling face identifying standard.

14. The medium of claim 13, wherein the predetermined smiling face identifying standard defines a similarity degree between the facial features of the intensity image and the facial features of the smiling image model.

15. The medium of claim 14, wherein the facial features comprise relative sizes and relative locations of hair, eyes, nose, and mouth of the user.

16. The medium of claim 13, wherein the intensity image is a black and white image.

17. The medium of claim 13, wherein the mobile electronic device is selected from the group consisting of a mobile phone, a personal digital assistant (PDA), a handheld game player, and a digital camera.

18. The medium of claim 13, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).
